(19) United States
(12) Patent Application Publication
(10) Pub. No.: US 2012/0198362 A1
(43) Pub. Date: Aug. 2, 2012

(54) Method and Device for Automatically Determining Control Elements in Computer Applications

(75) Inventors: Matthias Urban, Berlin (DE); Vikas Kapoor, Berlin (DE); Stefan Dahlke, Berlin (DE); Jochen Wiechen, Berlin (DE)

(73) Assignee: DATANGO AG, Berlin (DE)

(21) Appl. No.: 12/743,308

(22) PCT Filed: Jun. 11, 2009
(86) PCT No.: PCT/EP09/57247

§ 371 Date: Aug. 27, 2010

(30) Foreign Application Priority Data
Jun. 12, 2008 (DE) 10 2008 028 581.1

(51) Int. Cl. G06F 3/01

(52) U.S. Cl. 715/762

(57) ABSTRACT

In a method for automatically identifying at least one control element in an application view of an application a) at least one recognition pattern for structural and/or graphical features of the at least one control element is pre-stored in an object template, b) a recognition means generates structural and/or graphical data from the application view and examines the data according to the at least one recognition pattern, c) in dependence on the examination a measure for the recognition certainty of the at least one recognition pattern is determined, and d) in dependence on the obtained recognition certainty the status of the at least one control element is determined as “identified” or “not identified”.

The invention relates to a method for automatically identifying at least one control element in an application view of an arbitrary application and a device for automatically identifying at least one control element.

The complexity of computer applications increases constantly. Even relatively simple text processing programs nowadays comprise a functionality which is difficult to oversee. The complexity of programs for example for simulating technical processes (for example for simulating semi-conductor circuits or other electrical circuits), for financial book keeping, risk management or logistics is—by order of magnitudes—even higher. The handling of these computer applications for the individual therefore becomes ever more difficult. The handling of such computer applications through the manufacturer also becomes ever more complex, in particular because parallel changes in a program through different persons must be reflected in the documentation and in online help systems.

For the efficient production for example of teaching material and online help systems for existing applications it is necessary to use a specialized tool. This tool generates exact information about the look and behaviour of the graphical user interface and produces on this basis documents which for example can be used for the teaching support and in the online help.

For this, control elements such as for example buttons, input masks or choice boxes in the computer application must be automatically recognized. This information then can be used for example to automatically generate explanations for using the computer application. In this way, studying materials or documentations can be automatically generated.

In methods known so far for the recognition of control elements in computer applications, as far as known, mostly structural methods (MSAA, Windows API, . . . ) are used. Dependent on the application, however, via these interfaces those methods offer only more or less complete and correct information about the control elements, often even no information at all. Known recognition algorithms use the information of the structural methods in an unprocessed way and therefore are completely dependent on the interface information, whereby often gaps or errors in a control element recognition occur.

The instant invention is based on the object to provide a method and a device by which control elements in arbitrary applications can automatically be recognized consistently in every situation in a correct and precise automatic manner, wherein the applications by no means needs to be adapted for such recognition.

This object, according to the invention, is solved by a method with the features of claim 1 and a device with the features of claim 15.

The dependent claims protect advantageous embodiments of the invention.

With the method according to the invention and the device according to the invention a tool is provided which allows for an automatic recognition of control elements in arbitrary applications. The recognition herein can take place without a user interaction being necessary hereto, wherein different control elements of an application, for example different buttons, choice boxes or input masks, can in every situation be recognized in a precise and reliable manner.

A control element herein denotes an element of an application for example in the form of a button, a choice box, an input mask or the like, which for operating the application can be actuated, clicked or in another way operated by a user.

An application may be a computer application in terms of an arbitrary software application which is to be run on a computer.

The instant invention is applicable to arbitrary applications which in no way need to be particularly adjusted. The proposed method and the proposed device in this way form a tool that can be applied to an application, without the need of adapting the application, for example a computer program to be analysed, for this purpose.

The invention allows for the combination of graphical and structural recognition methods for extracting graphical and structural data from an application view of an application. In this way, control elements can be identified in the application view in a secure and reliable manner according to different information. If a structural recognition method does not provide sufficient information for identifying a control element, a graphical recognition method can be used (additionally or alternatively), according to which the control element can then be unambiguously identified.

Subsequently, the invention is explained in more detail with reference to the figures of the drawings according to multiple embodiments. Herein

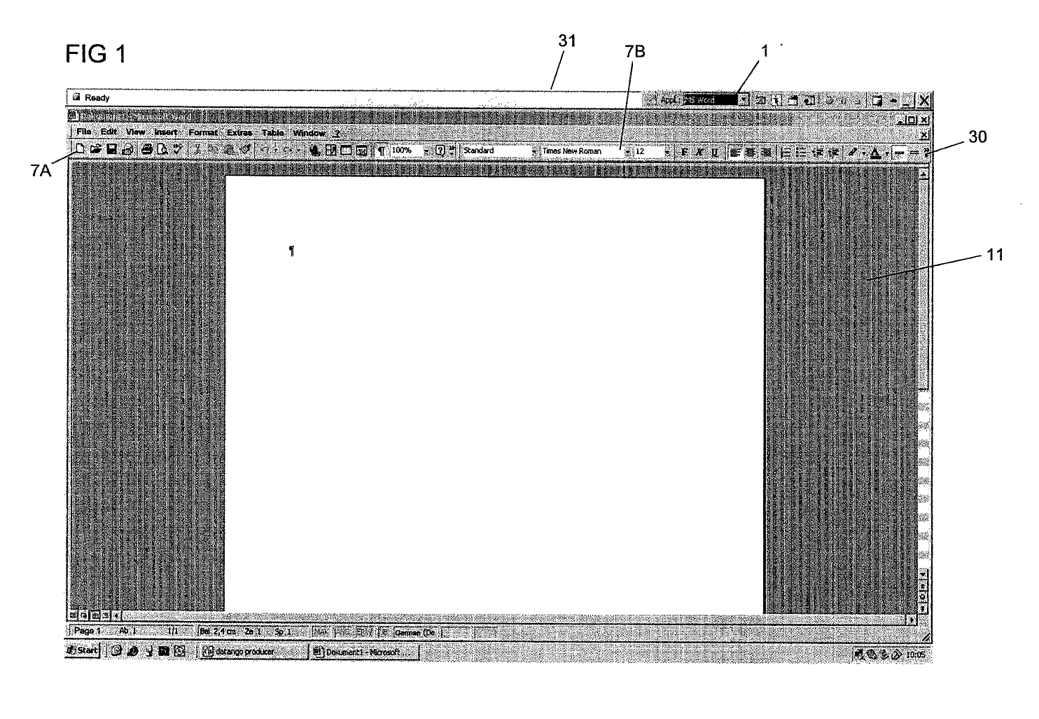

FIG. 1 shows a view of a typical computer application in connection with an embodiment of a program for automatically recognizing control elements;

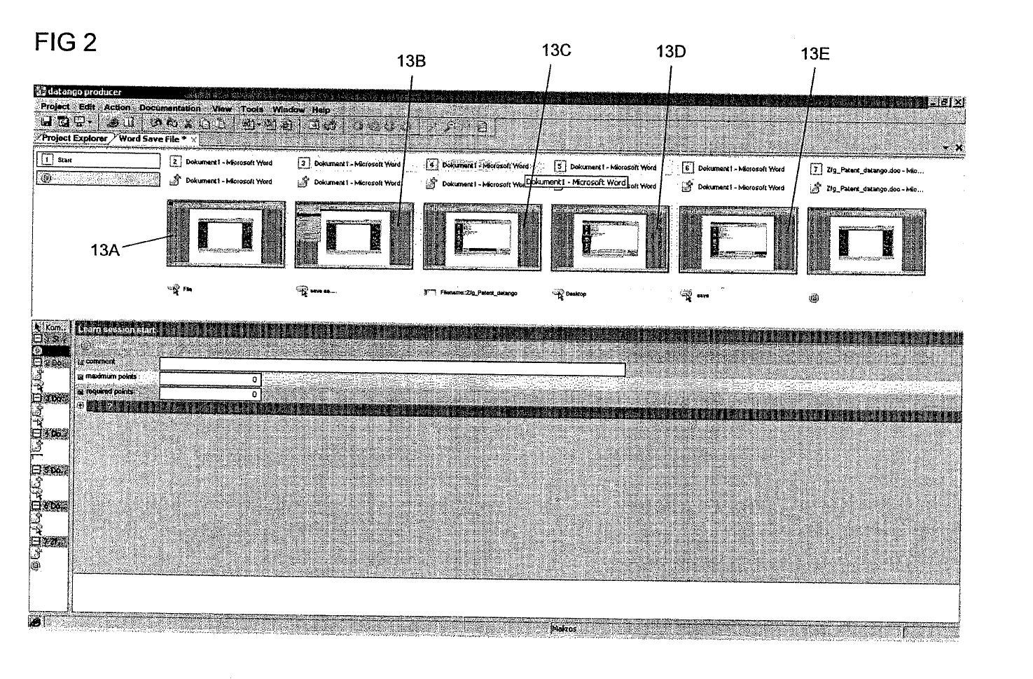

FIG. 2 shows an example of a recording process of the operation of the computer application;

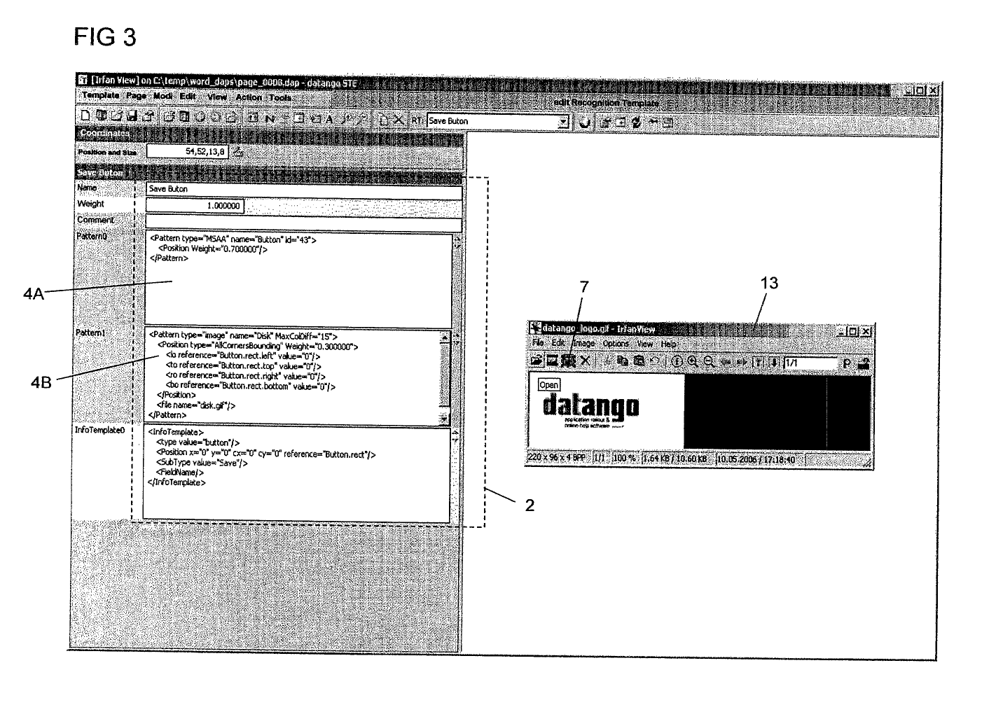

FIG. 3 shows an example of an object template;

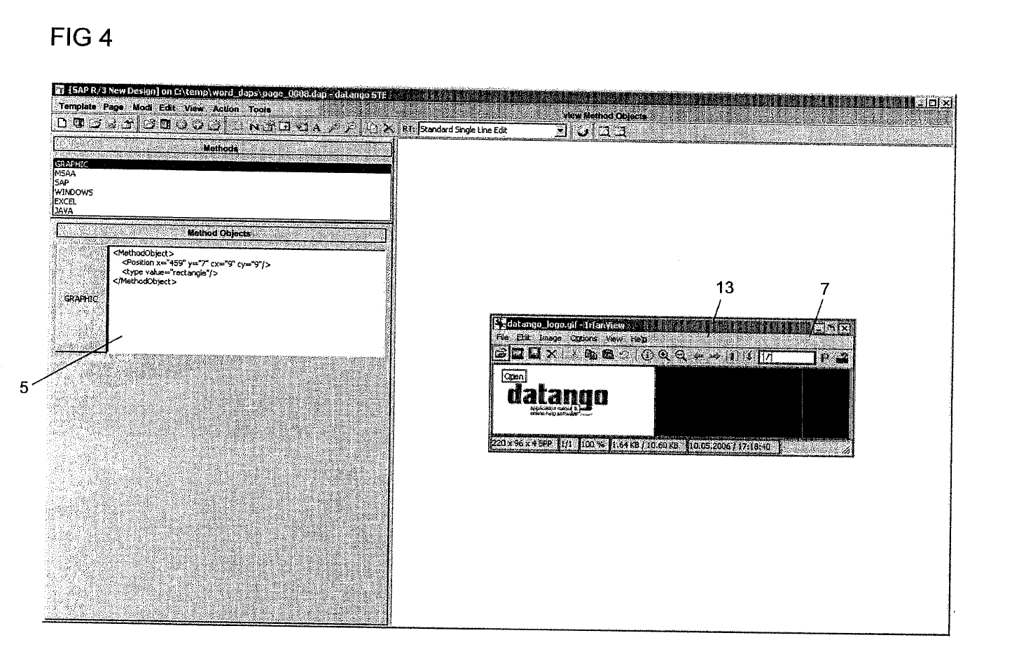

FIG. 4 shows an example of a graphical method object;

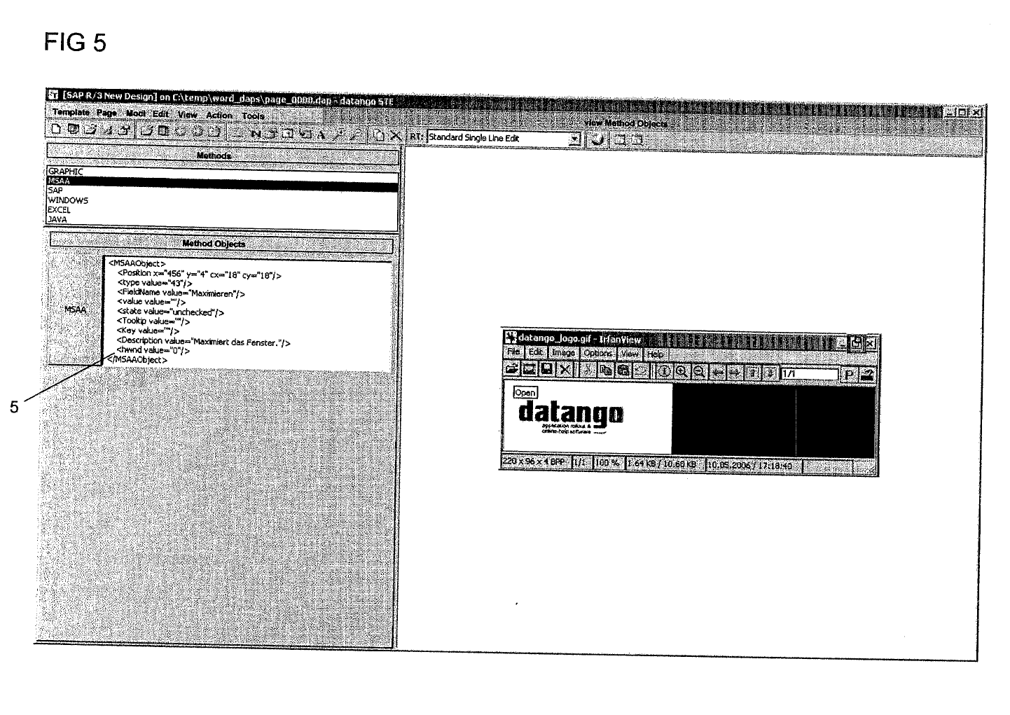

FIG. 5 shows an example of an MSAA method object;

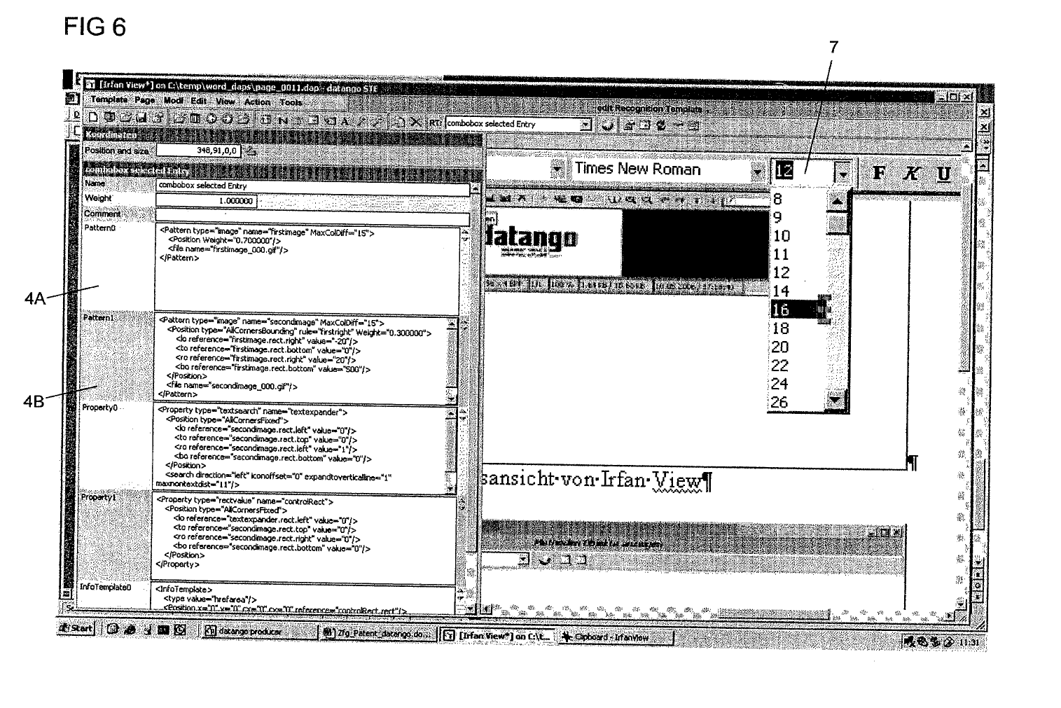

FIG. 6 shows an example of an object template for the chosen input of a pop-up list (Combo-Box);

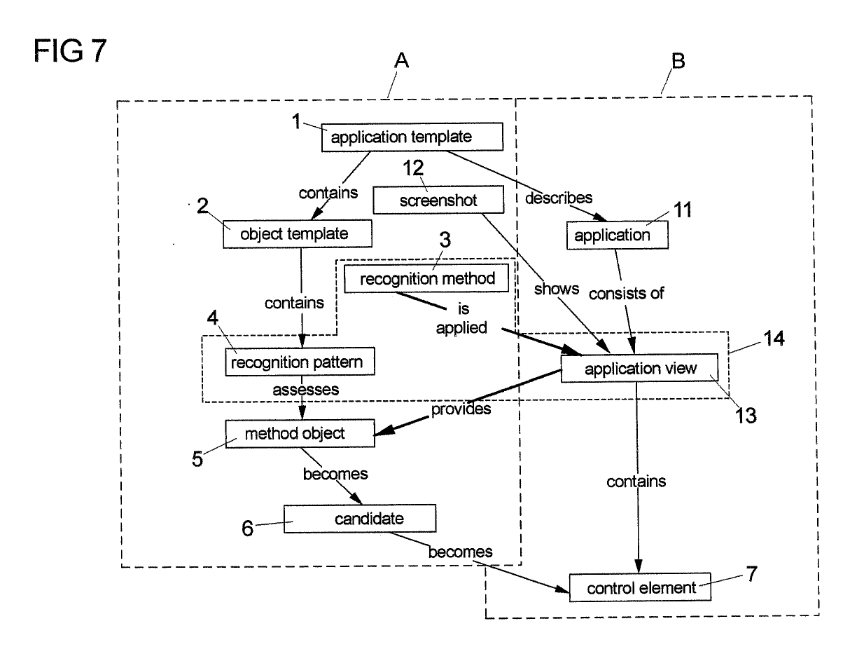

FIG. 7 shows a view of individual elements of an embodiment of the invention;

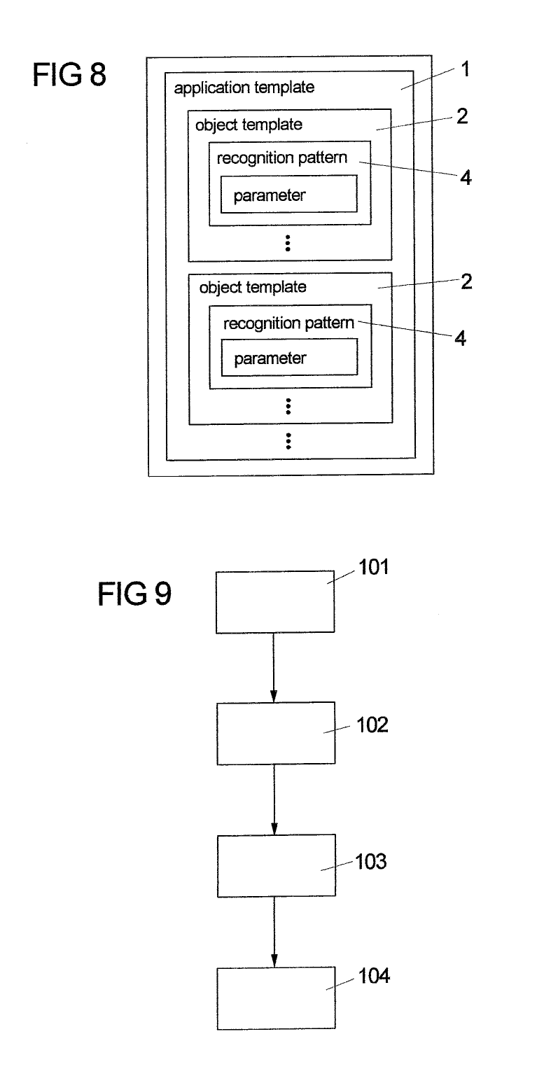

FIG. 8 shows a schematic view of the structure of an application template;

FIG. 9 shows a view of an embodiment of the invention in terms of a flow diagram;

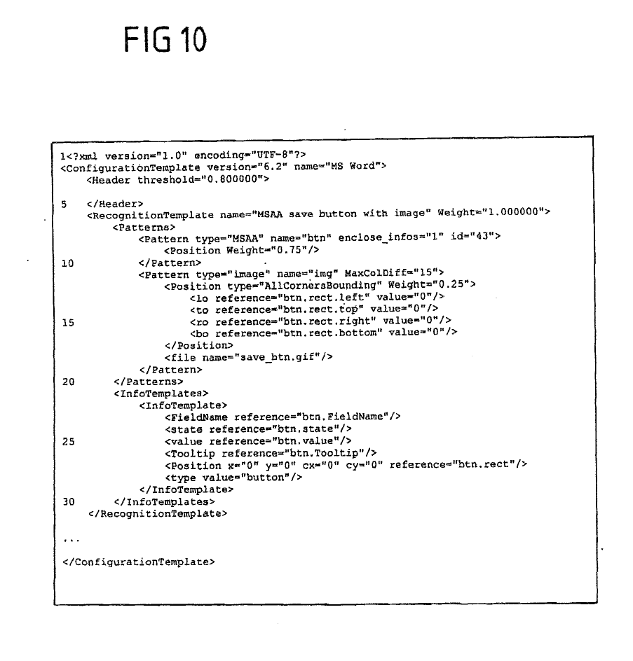

FIG. 10 shows a section of an XML-file of an application template with an object template;

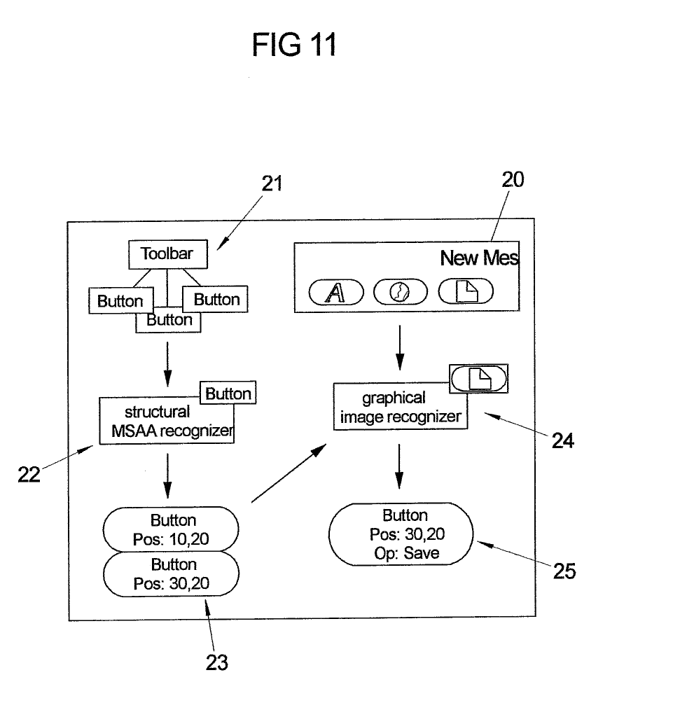

FIG. 11 shows a schematic view of a recognition of a button in an application view;

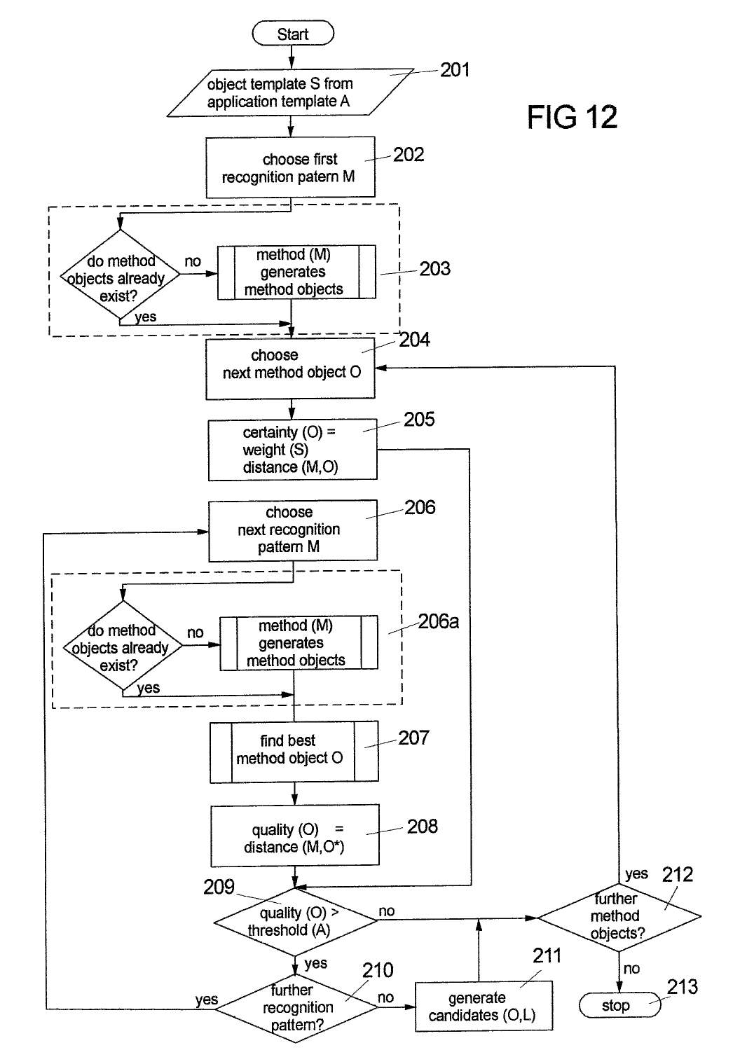

FIG. 12 shows a schematic view of a further embodiment in terms of a flow diagram.

According to specific examples, first, the functionality of a few embodiments of the method and the device shall be explained.

Herein, first of all according to FIGS. 1 and 2 it shall be explained how the method according to the invention is applied to an application 11 in terms of a software application to be run on a computer. The application 11 may for example be a text processing, wherein this by no means shall be limiting for the method according to the invention. The method according to the invention and, as well, the device according to the invention are applicable in general terms for different kinds of applications 11, wherein the applications 11 also may use different operating systems.

The method according to the invention (and in the same way the device according to the invention) serve for identifying control elements 7A, 7B within an application 11 in an automatic manner without a user interaction being necessary for this purpose. In this way during the execution of an application 11 information can be gathered and stored which for example makes it possible to record and document the operating process of an application 11 or to gather and store, during the execution of an application 11, information of different kinds.

FIGS. 1 to 2 show the automatic recognition of control elements 7A, 7B according to a typical PC application 11, such as a text processing or a graphic program. The invention, however, is not limited to these kinds of programs or PCs. In principle, also other applications 11 or other operating systems can be used in which control elements 7 are viewed.

During the execution of an application 11, for example the text processing according to FIG. 1, different application views are displayed in dependence on the operating process of the application 11 through a user. Application views are views that are visible for a user in a window on a monitor. The application views change, herein, in dependence on the operating steps executed by a user. Accordingly, for example menus occur, displayed toolbars (so called Toolbars) change their shape and so on.

In FIG. 1 an application view of a text processing program 11 is shown which shows an empty document. At the head of this document window a toolbar (Toolbar) is arranged which comprises various control elements 7. A first control element 7A is for example a switch field (also denoted as Button) for opening a new empty document. A second control element 7B is a combination field (a so called Combo-Box) which serves for choosing the font type. Multiple further control elements 7 are present by which the application 11 can be operated.

By means of the program 31, which provides embodiments of the method according to the invention and the device according to the invention, arbitrary processes of the application 11 can be recorded. Herein the application 11 executes its actions in an unhindered manner and familiar way. During the recording process the individual application views are analysed, all information is extracted, among others control elements are recognized and stored in the program 31.

It is the goal of the example shown in the following to automatically generate from the operation of the application 11 a functional description of the application 11 by means of an automatic recognition of control elements 7. The person skilled in the art recognizes that this example does not limit the invention, but only is an example for many applications.

For example the user performs different operating steps in order to store a document in a particular folder on the computer. For this, he must click, with a computer mouse, in a per se known manner on different control elements 7 of the application 11 and must enter inputs for the file name into masks and/or must execute keyboard commands.

During the operation of the application 11 the program 31 records, after each operation action of a user, the resulting application view. FIG. 2 shows the result of a recording of these steps. After each action an application view 13A-E is generated and stored by the program 31 in order to analyse it at a later time. In FIG. 2 for example in a first application view 13A the state after pressing the button for the command “file” is shown.

As commonly known, after pressing the button “file” a drop-down menu with different functions is displayed. One of these is the command “safe as . . . ”. The second application view 13B shows the choice option for the command “safe as . . . ”.

The third application view 13C shows a new window in which the file name and the memory location can be specified.

The fourth application view 13B shows one of the possible choice options for a memory location, namely the desk top.

The fifth application view 13E shows the choice of a control element 7 for storing.

In the application views 13A-E differently shaped control elements 7 are used which are automatically recognized by embodiments of the method according to the invention, wherein it is possible through the automatic recognition of the control elements 7 in the application views 13A-E to follow and to record the operating process.

In the upper bar of the program 31 shown in FIG. 1 a pop-up list is arranged by which different so called application templates 1 can be chosen. The program 31 comprises for this purpose a number of application templates 1 in which prestored object templates 2 for recognizing control elements 7 in a particular application as well as global settings for the recognition are stored. Typical application templates 1 for example can relate to a text processing, a spreadsheet processing, a presentation software, a database system or an accounting software.

By way of example in FIG. 10 an extract of a source code of an application template 1 is shown which comprises exactly one object template 2.

In an application template 1 associated with a particular application 11 at least one object template 2 is comprised. An object template 2 contains information about a class of control elements 7 of the particular application 11 in terms of so called recognition patterns. Hence, an object template 2 can contain information for example about all switch fields (so called “Buttons”, i.e. a particular control element type) of an application 11. A further control element type is for example a “ComboBox”, wherein a further example of a specific class is a “ComboBox” with a grey frame with a height of 20 Pixel and a black triangle in its right region.

Each object template 2 is associated with a weight which indicates the precision with which an object template 2 describes a control element 7. The weight herein depends on the type of the information contained in an object template 2: for example an MSAA (Microsoft Active Accessibility) description of a control element 7 in general is more precise than a description via graphical elements (in this regard see below in detail).

Such an object template 2 with recognition patterns 4A, B and their parameters is shown FIG. 3 in the left half. In the right half an application view 13 of a graphics program can be seen, the object template 2 being applied to the application view 13 within the later recognition method.

In the shown example the recognition of the control element 7 “safe file” is concerned which is used in the application 11 as switch field having a disc symbol.

The object template 2 comprises multiple recognition patterns 4A, 4B which, in different ways, describe the control element 7.

The first recognition pattern 4A uses information according to the interface MSAA (Microsoft Active Accessibility), which is provided by the application 11 in a defined manner and in which control elements 7 are characterized for example by so called ID numbers. In the present example, the control element 7 is for example associated with the ID number 43.

The second recognition pattern 4B uses completely different information, namely information about the geometric shape in connection with the usage of a symbol, which here is stored in terms of the image “disk.gif”.

In the context of the method according to the invention a multiplicity of object templates 2 can be provided which for analysing the application 11 one after the other are compared with graphical elements, for example the control elements 7, of the application views 13A-E.

For recognizing control elements 7 in individual application views 13A-E in general—as will be explained subsequently—it is proceeded such that one or multiple so called recognition methods are applied to an application view 13A-E which provide as results so called method objects. These method objects are then compared with prestored recognition patterns to determine whether a control element 7 is present in an application view 13A-E or not.

For two methods, namely a graphical recognition method and a structural recognition method, in FIGS. 4 and 5 resulting method objects 5 are shown. FIG. 4 shows, herein, a method object 5 associated with a graphical rectangle method, and FIG. 5 shows a method object 5 associated with an MSAA method representing a structural recognition method. In each case, the object about the “Maximize” button is selected. Both method objects 5 may be compared with two corresponding, prestored recognition patterns as combination for identifying a control element 7 (in this case the “Maximize” button).

In FIG. 6 a screen shot showing an application view is shown in which the selected element of a pop-up list or a combination field is visible as an example for a control element 7. This is described by means of two graphical recognition patterns 4A, 4B of the type “image” (recognition pattern 4A: downwards arrow in the field; recognition pattern 4B: blue pixel of the list element). Via the combination field the choice of the font size becomes possible. For the recognition it is utilized that in the popped-up list the active element (in this case the specification “16”) is emphasised through a different coloring.

Possible embodiments of methods for automatically identifying at least one control element 7 in an application view 13A-E of an application 11 shall be described subsequently according to FIG. 7 to FIG. 12.

FIG. 7 schematically shows the interaction of an embodiment of the method according to the invention with an application 11 to be analysed. In this regard, in FIG. 7 schematically two regions A and B are shown, wherein the region A is associated with the embodiment of the invention which processes information of the computer application within region B. The interaction of the invention with the application 11, i.e. the application view 13, is shown in FIG. 7 through arrows. Furthermore, the individual elements are shown in their operative relationship.

The objects shown in FIG. 7 and described subsequently may be implemented as software or in terms of hardware, for example as an ASIC-chip. It is also possible to use a combination of soft- and hardware.

In the following, an application 11 denotes an arbitrary computer application, meaning a computer program, which is to be analysed or examined by an embodiment of the method according to the invention or an embodiment of a device according to the invention. The application 11 is not especially equipped for this analysis or examination and needs to support the intervention through the method or device in no particular fashion.

An application view 13 is one of multiple views which is displayed to a user during operation of the application. A common form of an application view 11 is for example a standard form which the user must fill in, a view of an empty document of a text processing comprising a toolbar (Toolbar) 30, as shown in FIG. 1, or a setting dialogue in a text processing or an operating system. An application 11, in general, comprises a multiplicity of application views 13.

An application view 13 comprises at least one control element 7. Typical examples for control elements 7 are switch fields, input or choice fields, menus, menu inputs, marking fields, option fields, tree entries. Through an analysis of an application view 13 sets of control elements 7 can be determined.

From the application view 13 a screen shot 12 must be distinguished. The screen shot 12 represents a raster image of an instant snapshot of an application view 13.

The objects of the region A in FIG. 7 in general are part of an embodiment of the device or the method.

During the method for automatically identifying control elements 7 in an application view 13A- E of an application 11 it is proceeded from an application template 1 which, as schematically shown in FIG. 8, comprises at least one object template 2. In FIG. 10 an application template 1 in the form of an extract of an XML file is shown.

The application template 1 comprises object templates 2 for an application 11 (FIG. 8). Thereby the set of overall identifiable control elements 7 within an application view 13 of an application 11 is defined.

The object template 2 comprises at least one pre-stored recognition pattern 4 (FIG. 8) which represents a set of parameters which describe a specific type of method objects 5 of a specific recognition method 3. For each object template 2 a weight is specified which specifies the precision of the description of this class.

If in an application view 13 control elements 7 shall be identified, a recognition method 3 is applied to the application view 13 through a recognition means 14. The recognition method 3 provides, as result, method objects 5 which subsequently are assessed by applying recognition patterns.

All application templates 1 and object templates 2 are pre-produced for the views of an application 11 and, at the time of the recognition, are available in storage.

The recognition method 3 generates method objects 5 from the application view 13. The characteristics of the method objects 5 are compared with the parameters of the recognition patterns 4; if these match sufficiently well, from the initial method objects 5 potential candidates 6 for control elements 7 arise.

The used recognition methods 3, in principle, can be divided in two classes, namely structural and graphical methods.

Structural recognition methods 3 require that an application is cooperative and, via defined interfaces, provides information about the structure of an application view 13. Specific examples for usable interfaces in computer applications are:
Windows API: Standard Windows programming interface for graphical user interfaces; is practically used in all native Windows applications.
MSAA (Microsoft Active Accessibility): Programming interface for handicapped accessible input and operating helps; is supported by many applications at least in part.
Java Access Bridge: Allows Windows applications to access the Java accessibility API of Java applications.
WEB: Access of data of browsers by means of DOM (Document Object Model).
SAPGUI Script: Allows Windows applications to access application data of SAPGUI by means of the scripting interface implemented herein.
MS Excel Native Object Model: Allows Windows applications to access application data of MS Excel.
MS Word Native Object Model: Allows Windows applications to access application data of MS Word.

The embodiments of the method and the device are, as mentioned above, not limited to windows applications 11. Also, applications 11 which are operable under other operating systems can be examined using the method and the device.

If for example Windows API is used as interface, within the recognition pattern 4 the class name of the window class to be recognized is stored, and all windows of an application view 13 with their class names result as method objects 5. The comparison of the parameters corresponds to the comparison of the class name stored in the recognition pattern 4 with the class name of the actual method object 5 (window). If these match, the recognition distance is zero; otherwise the recognition distance corresponds to the weight of the recognition pattern, in a specific embodiment the weight of the position.

The term recognition distance will be explained in more detail in a later section within the context of the recognition process.

If HTML, Excel, SAPGUI Script, Java or MSAA is used as interface, within the recognition pattern 4 the type of the object is stored (for example switch field, text field, table cell and so on), and the method objects 5 are all objects of an application view 13 resulting from the recognition method 3 in the particular case. The comparison of the parameters corresponds to the comparison of the type stored in the recognition pattern 4 (denoted by the ID number (“Id”)) with the type of the instant method object 5. If these match, the recognition distance is zero; otherwise the recognition distance is the weight of the recognition pattern, in a specific embodiment the weight of the position.

Structural recognition methods communicate with the application 11 via the described interfaces and can be used only if a running instance of the application 11 is present.

Graphical recognition methods, in contrast, operate on a screen shot 12 of an application view 13 and orient themselves only on the optical appearance of the control elements 7. It is assumed that the control elements 7 are made up of graphical primitives that are simple to recognise. Two primitives of particular importance are:

Images: If images are used as graphical primitives, within the recognition pattern 4 the file name of the image to be searched for is stored, and the method objects 5 are all possible pixel areas of the screen shot 12 of an application view 13. The comparison of the parameters corresponds to the search for the image stored in the file in the screen shot 12 within the specified region. If the image is found, the recognition distance is zero; otherwise the recognition distance is the weight of the recognition pattern, in a specific embodiment the weight of the position.

Rectangles: If rectangles are used as graphical primitives, within the recognition pattern 4 eight colors are stored which specify the edge colors of a rectangle, namely at points top left, top middle, top right, right middle, right bottom, bottom middle, bottom left, left middle. Each of these colors is associated with a weight. The method objects 5 are all rectangles of the screen shot 12 of an application view 13. The comparison of the parameters is the comparison of the edge colors of each rectangle with the colors stored in the recognition pattern 4. A recognition distance, which is initialized with zero, is computed in the following way: If an edge color on the respective position does not match with the one stored in the recognition pattern 4, the recognition distance is increased by the corresponding weight of the color. After the comparison of the eight colors, hence, a final recognition distance arises. If a rectangle recognition pattern is not used as initial (first) recognition pattern 4 within an object template, the rectangle described by its color points is searched for exactly at the location described by the position. If there is no rectangle at that position, the recognition distance is increased by the weight of the position and the weight of the sum of all color weights. If a rectangle is found exactly at the location, the color points are compared as described above.

Graphical recognition methods do not require a running instance of the application 11. They provide, as sole information, the exact position of the recognized image element.

All methods can be used individually or in combination with each other.

The specific characteristic of the described method lies in the use of graphical recognition methods 3 for recognizing control elements 7 as well as the flexible combinability of structural and graphical recognition methods 3. For the description of a particular class of control elements 7 the recognition methods 3 can be arbitrarily combined with each other to describe control elements 7 correctly in all details.

Furthermore, the described method offers the possibility to recognize control elements 7 about which no structural recognition method 3 can provide information. For example, in this way text fields can be determined by means of graphical rectangles and their edge color points.

In addition, a more precise specification and/or a correction of unprocessed information of the structural recognition methods 3 are possible.

As an example for a more precise specification for example the “safe” button can language-independent be distinguished from other buttons in that an image is used as a further feature of the associated control element 7.

As an example for a correction: What a user sees as a button not necessarily is denoted as a button in a structural recognition method 3, but for example may be denoted as a text field. Within an object template 2, however, the possibility exists to correct the received information of the structural recognition method 3 through additional use of a graphical recognition method 3 and comparison of the resulting method objects 5 with a graphical recognition pattern 4 and to declare it as a button.

A further example for the correction: The structural MSAA method generates method objects of a type “outlineitem” with an ID number 36 (type=36). The user, however, sees this in the application as “button”. In this case, one has the possibility within the object template to declare recognized patterns of the type “outlineitem” as button.

In FIG. 9 the general process of an embodiment of the method according to the invention is shown schematically and summarized to the essential, the method being applied to an application view 13 of an application 11 in terms of a computer program.

In the first method step 101 at least one recognition pattern 4 for structural or graphical features of at least one control element 7 is pre-stored in an object template 2. This represents an initial configuration step which for each application 11 must be carried out in advance only once.

In the second method step 102—during the actual execution of an application 11—a recognition means 14 generates structural and/or graphical data of an application view 13 and examines the data making use of the at least one recognition pattern 3 (in the exemplary embodiment yet to be described below according to FIG. 12 this can encompass the steps 202 to 205 or 206 to 208, respectively).

In the third method step 103 in dependence on the examination a measure for the recognition certainty of the at least one recognition pattern 3 is determined (in the exemplary embodiment according to FIG. 12 this can contain the steps 209 and 210).

In the fourth method step 104 in dependence on the obtained recognition certainty the status of a control element 7 is defined, i.e. it is set to “identified” or “not identified”.

In the following, a specific embodiment of the invention shall be explained in more detail in accordance with the flow diagram of FIG. 12.

The method according to FIG. 12 is initiated through the extraction of the list of the object templates 2 from the application template 1; these are considered in the order given through their weight. For this, the recognition method 3 of the first recognition pattern 4 listed in an object template 2 is applied to the application view 13 (steps 201, 202, 203).

Step 203 serves for generating the method objects 5 through application of the recognition method 3 (which is associated with the recognition pattern 4 considered in each case) to the application view 13. The generation of the respective method objects 5 herein needs to be executed only if these method objects 5 have not already been generated previously. If the respective (graphic or structural) recognition method 3 has been applied previously already to the application view 13 and if the method objects 5 therefore exist already, the recognition method 3 does not have to be applied to the application view 13 again. It is proceeded immediately with step 204.

The result is a list of potential control elements 7, namely the method objects 5. Besides the attributes recognized by the respective method, as for example position and dimension, for each method object 5 an initial recognition certainty is specified. The initial recognition certainty results from the weight of the object template 2 minus the recognition distance between the first recognition pattern 4 and the method object 5. The recognition distance is determined through comparison of the attributes of a method object 5 with the parameters of the generating recognition pattern 4. The less agreement exists, the larger the distance is (step 205). In the further process of the method the recognition certainty is rendered more precisely as measure for the quality of the recognition.

For each method object 5 in this primary list, then, all further recognition patterns 4 of the instant object template 2 are considered (step 206). For each recognition pattern 4 the specified recognition method 3 is again applied to the application view 13, if this has not taken place previously and the method objects 5 associated with this recognition method 3 do not already exist (step 206a). This time, however, the search region can additionally be limited by using the already determined attributes of the method objects 5 already recognized. In this way the recognition performance can be increased while at the same time reducing the computational costs.

The result of this search is again a list of method objects 5. If multiple method objects 5 within a search region exist, the one with the smallest recognition distance is considered further, all other method objects 5 are discarded (steps 207, 208). The recognition distance of this method object 5 is subtracted from the recognition certainty of the currently considered method object 5. If thereby the recognition certainty decreases below the threshold value defined in the application template 1, all method objects 5 which belong to the instantly considered method object 5 of the primary list, are discarded (step 209). Otherwise, one or more control element candidates 6 are generated from the instant method objects 5 and are stored in a global list (step 211).

After all primary method objects 5 have been processed in this way, it is proceeded with the next object template 2.

The list of all candidates generated during the process is subsequently sorted according to the recognition certainty and is checked for spatial overlap of the candidates.

For this, a list of control elements 7 is stored for which a candidate 6 is added only if its spatial dimension does not cover a control element present already in the list. After consideration of all candidates the list of control elements 7 represents the result of the method according to FIG. 12.

According to a specific example the method according to FIG. 12 may proceed as follows.

Within an application template 1, in general, multiple object templates 2 (see also FIG. 8) are present. In a specific example these shall be the three object templates 2:
A. “combobox selected entry”
B. “MSAA Button”
C. “MSAA Underline Button”.

The XML representation of the application template 1 with the three object templates 2 is given as follows:

```
<?xml version=“1.0” encoding=“UTF-8”?>
<ConfigurationTemplate version=“6.2” name=“Patent Example”>
    <Header threshold=“0.800000”>
    </Header>
    <Global>
        <GRAPHIC Force8bit=“0”>
        </GRAPHIC>
    </Global>
    <RecognitionTemplate name=“combobox selected entry” Weight=“1.0”>
        <Patterns>
            <Pattern type=“image” name=“firstimage” MaxColDiff=“15”>
                <Position Weight=“0.700000”/>
                <file name=“firstimage_000.gif”/>
            </Pattern>
            <Pattern type=“image” name=“secondimage” MaxColDiff=“15”>
                <Position type=“AllCornersBounding” rule=“firstright”
Weight=“0.3”>
                    <lo reference=“firstimage.rect.right” value=“−20”/>
                    <to reference=“firstimage.rect.bottom” value=“0”/>
                    <ro reference=“firstimage.rect.right” value=“20”/>
                    <bo reference=“firstimage.rect.bottom” value=“500”/>
                </Position>
                <file name=“secondimage_000.gif”/>
            </Pattern>
        </Patterns>
        <Properties>
            <Property type=“textsearch” name=“textexpander”>
                <Position type=“AllCornersFixed”>
                    <lo reference=“secondimage.rect.left” value=“0”/>
                    <to reference=“secondimage.rect.top” value=“0”/>
                    <ro reference=“secondimage.rect.left” value=“2”/>
                    <bo reference=“secondimage.rect.bottom” value=“0”/>
                </Position>
                <search direction=“left” iconoffset=“0”
expandtoverticalline=“1” maxnontextdist=“11”/>
            </Property>
            <Property type=“rectvalue” name=“controlRect”>
                <Position type=“AllCornersFixed”>
                    <lo reference=“textexpander.rect.left” value=“0”/>
                    <to reference=“secondimage.rect.top” value=“0”/>
                    <ro reference=“secondimage.rect.right” value=“0”/>
                    <bo reference=“secondimage.rect.bottom” value=“0”/>
                </Position>
            </Property>
        </Properties>
        <InfoTemplates>
            <InfoTemplate>
                <type value=“hrefarea”/>
                <Position reference=“controlRect.rect”/>
                <SubType value=“ComboBoxListItem”/>
                <FieldName reference=“textexpander.text”/>
            </InfoTemplate>
        </InfoTemplates>
    </RecognitionTemplate>
    <RecognitionTemplate name=“MSAA Button” Weight=“0.990000”>
        <Patterns>
            <Pattern type=“MSAA” name=“btn” enclose_infos=“1” id=“43”>
                <Position Weight=“1.000000”/>
            </Pattern>
        </Patterns>
        <Properties/>
        <InfoTemplates>
            <InfoTemplate>
                <type value=“button”/>
                <Position reference=“btn.rect”/>
                <FieldName reference=“btn.FieldName”/>
            </InfoTemplate>
        </InfoTemplates>
    </RecognitionTemplate>
    <RecognitionTemplate name=“MSAA Underline Button” Weight=“1.000000”>
        <Patterns>
            <Pattern type=“MSAA” name=“btn” enclose_infos=“1” id=“43”>
                <Position Weight=“0.700000”/>
            </Pattern>
            <Pattern type=“image” name=“underline_image” MaxColDiff=“15”>
                <Position type=“AllCornersBounding” Weight=“0.300000”>
                    <lo reference=“btn.rect.left” value=“0”/>
                    <to reference=“btn.rect.top” value=“0”/>
                    <ro reference=“btn.rect.right” value=“0”/>
                    <bo reference=“btn.rect.bottom” value=“0”/>
                </Position>
                <file name=“underline_image.gif”/>
            </Pattern>
        </Patterns>
        <Properties/>
        <InfoTemplates>
            <InfoTemplate>
                <type value=“button”/>
                <Position reference=“btn.rect”/>
                <FieldName reference=“btn.FieldName”/>
            </InfoTemplate>
        </InfoTemplates>
    </RecognitionTemplate>
</ConfigurationTemplate>
```

For the three object templates the following weights are defined:
1. “combobox selected entry” weight=“1.0”
2. “MSAA Underline Button” weight=“1.0”
3. “MSAA Button” weight=“0.99”

The application view 13 for this example shall exactly correspond to the one in FIG. 6 with the popped-up pop-up list (application MS Word, main window) and herein exactly only the visible region.

The embodiment of the method according to the invention, as described in FIG. 12, requires that the application template 1 and the application view 13 have been provided. The application template 1 was described above according to the XML code.

If in the application view 13 the control elements 7 defined by the object templates 2 shall be recognized, the command “recognize control element” is executed, i.e. the method according to FIG. 12 is carried out.

First, the object templates 2 are sorted in the order of their weight (large→small).

Then, the object template 2 with the largest weight, “combobox selected entry”, is chosen (step 201 in FIG. 12). From this object template 2 the first recognition pattern with the name “first image” is called up (step 202).

For the graphic recognition method (which is associated with the recognition pattern of the type “image”) the method objects 5 are present already in terms of the screen shot 12 (step 203); they correspond in this context to all pixel areas having a rectangular shape of all possible size combinations.

Now, the first method object 5 is chosen (step 204), the initial recognition certainty for this method object 5 is set to 1.0, and the image “firstimage_{—}000.gir is compared with the method object 5 (step 205).

If the instantly considered method object 5 corresponds to the “black arrow downwards”, 0.0 is subtracted from the initial recognition certainty. The recognition certainty still amounts to 1.0. Subsequently, the next recognition pattern “secondimage” is chosen (see steps 209, 210, 206 in FIG. 12).

If the instantly considered method object 5 does not correspond to the “black arrow downwards”, the value of the position weight (“weight”) of 0.7 is subtracted from the initial recognition certainty. In this way, a recognition certainty of 0.3 results; this, however, is smaller than the pre-defined global threshold of 0.8, such that it is proceeded with the next method object 5 (steps 209, 212, 204 in FIG. 12).

In the application view 13 the “black arrow downwards” (namely the recognition pattern “firstimage”) is found exactly three times. I.e. for exactly three of the original very many method objects 5, then, the recognition pattern “secondimage” is chosen (step 206 in FIG. 12). The recognition pattern “secondimage” (a vertical blue strip having a width of 1 pixel and a height of 18 pixel) is searched for within the search region given for the recognition pattern “secondimage” through the position (FIG. 12: it is compared with all graphical method objects 5 within the search region), wherein 0 . . . N “matching” method objects 5 may be contained in the search region (step 207 in FIG. 12).

Beneath the “style” pop-up list and the “font type” pop-up list (see FIG. 6) no blue column is found, i.e. here zero method objects are found in the search region, the recognition certainty is reduced by the position weight of 0.3, now amounts to 0.7 and therefore lies beneath the global threshold of 0.8 (steps 208, 209 in FIG. 12).

In this case it is proceeded with step 212 in FIG. 12.

Beneath the “font size” pop-up list (FIG. 6) the recognition pattern “secondimage” can be found multiple times, and the “most suitable ” (best) is chosen, namely the first method object to the right corresponding to the recognition pattern “secondimage” (according to the rule “firstright” defined within the object template 2 under “position”; step 207). The recognition certainty (quality) still lies at 1.0 (step 208 in FIG. 12), because an object was found. It therefore still is larger than the threshold (boundary value) of 0.8 and, because no further recognition patterns can be found (step 210), a candidate is generated for the instantly considered initial method object 5 (meaning the “black arrow downwards” lying farthest to the right) (step 211 in FIG. 12).

A candidate 6 in the present context is a potentially recognized control element 7 which is linked with a measure specifying the quality of the recognition. This measure is generated automatically in the process of the recognition. In the instant case, the candidate occupies, after all recognition patterns 4 have been processed, exactly the area of the blue selected entry within the pop-up list in the application view 13 (FIG. 6) and has the recognition certainty 1.0.

Now, the second object template “MSAA Underline Button” is processed (starting with step 201).

The first recognition pattern 4 with the name “btn” is of the type MSAA and is chosen (step 202). The method MSAA is applied to the application view 13 and all MSAA method objects 5 are extracted (step 203). The first extracted MSAA method object 5 is chosen (step 204), and the first recognition pattern 4 of type MSAA is compared with the first MSAA method object 5.

If the ID number of the recognition pattern 4 does not match with the type of the method object 5, the weight of the position is subtracted, i.e. 0.7, such that the recognition certainty now amounts to 0.3, and it is proceeded with the next method object 5.

If the ID number matches with the type of the method object 5 (43), the resulting recognition certainty is 1.0, i.e. it is larger than 0.8, the defined boundary value (steps 205, 209).

Then, the second recognition pattern 4 with the name “underline_image” which is of the type “image” is chosen (steps 210, 206) and the image “underline_image.gir (the underlined “u”) is searched for. If it is found, the recognition certainty stays at 1.0, and a candidate 6 is generated. Otherwise the recognition certainty is reduced to 0.7. Thus, it lies beneath the boundary value, and it is proceeded with further method objects 5.

Overall, the object template “MSAA Underline Button” generates one candidate, namely exactly the underline button. The first recognition pattern 4 herein recognizes three objects: “bold, italic, underline” (see FIG. 6 top right). Through the second recognition pattern 4 the set of candidates is reduced to one.

Now, the third object template “MSAA Button” is applied 201. The first recognition pattern 4 with the name “btn” is of the type MSAA and is chosen (step 202). The MSAA method objects 5 already exist (these have been already generated through the second object template) and are used (step 203). The first extracted MSAA method object 5 is chosen (step 204), and the first recognition pattern 4 of type MSAA is compared with the first MSAA method object 5.

If the ID number matches with the type of the method object 5 (in this case having the value 43), the resulting recognition certainty is 1.0, i.e. larger than 0.8, the pre-defined boundary value. Further recognition patterns 4 do not exist; a candidate is generated with the recognition certainty 0.99 (steps 205, 209, 210, 211 in FIG. 12).

If the ID number does not match with the type of the method object 5, the weight of the position is subtracted, namely 1.0, such that the recognition certainty now amounts to 0.0. It is proceeded with the next method object 5, if it exists; otherwise it is stopped (steps 209, 212).

Overall, through the object template “MSAA Button” three candidates with the recognition certainty 0.99 are generated:
1. the bold button
2. the italic button
3. the underline button

After all object templates have been applied to the application view 13, the following candidate list results, forming the basis for the control element generation:
1. blue selected list entry, recognition certainty 1.0, generated through “combobox selected entry”
2. underline button, recognition certainty 1.0, generated through “MSAA Underline Button”
3. bold button, recognition certainty 0.99, generated through “MSAA Button”
4. italic button, recognition certainty 0.99, generated through “MSAA Button”
5. underline button, recognition certainty 0.99, generated through “MSAA Button”

This list is sorted according to the recognition certainty of the candidates 6.

The method now automatically steps through the list and generates from each of these candidates 6 a control element 7, if the position at which the instant candidate wants to generate its control element 7 is not already occupied through an existing control element 7 (generated already previously by a weightier candidate 6). Therefore, a list of four control elements results:
1. blue selected list entry, recognition certainty 1.0, generated through “combobox selected entry”
2. underline button, recognition certainty 1.0, generated through “MSAA Underline Button”
3. bold button, recognition certainty 0.99, generated through “MSAA Button”
4. italic button, recognition certainty 0.99, generated through “MSAA Button”

This represents the result of the method: Four control elements 7 have been identified in the application view 13 (FIG. 6 right).

In the following, individual lines in FIG. 10 are explained:

Line 2: Configuration template: Here, the application template 1 is specified giving the name and the version.

Line 3: Header information of the application template 1, threshold==boundary value. If the recognition certainty of a control element 7 of an object template 2 within the recognition process falls beneath the boundary value, the method object 5 of the first recognition pattern is discarded, the recognition process is interrupted and is continued with the next method object.

Line 4: Information for identifying the application.

Line 6: RecognitionTemplate==object template 2. Within the instant example the “safe” button is concerned. Here, the global parameters of the object template 2 are set. The weight corresponds to the initial recognition certainty of the recognition process for a method object 5.

Lines 8-10: Pattern==recognition pattern 4, the first pattern is of type “MSAA”. Further parameter information follow, in particular the weight (“weight”): If the ID number “ID” does not match with those of the method objects 5, this weight is subtracted from the initial recognition certainty, and the recognition distance is increased.

Lines 11-19: the second pattern is of type “image”. Further parameter information follow, in particular the weight (“weight”): If the file “safe_btn.gif” specified under “file” is not found within the search region given through the “position”, the recognition distance is increased by 0.25.

Lines 22-29: Control element candidate 6 which obtains its characteristics from the results determined in the recognition process of the recognition patterns processed previously.

In FIG. 11 a further example is shown schematically: top right a typical section of an application 20 is displayed, it contains among others a button for a “safe” function. The button represents a control element 7. The safe function is arranged as a switch field (“Button”) in a toolbar (“Toolbar”). In the tree 21 it is shown that the object “Toolbar” comprises three “Button” objects.

In this view the button for saving shall be identified, wherein in step 22 first structural information is assessed. Via the MSAA interface in step 23 multiple buttons with information regarding the position are recognized, at first nothing is known about the function of the button.

Subsequently, in step 24 by help of the graphical recognition using a reference image it is determined which button represents the one for saving information. This information then is stored as a data set 25.

Herein, the graphical recognition pattern uses the already known position information as start position for the search for the reference image. Thereby the search region is substantially reduced and the recognition time is decreased. At the end a candidate 6 for the control element 7 is available in terms of a data set 25, for which the position and the function are known.

The invention is not limited in its implementation to the previously stated preferred embodiments. Rather, a number of variants are conceivable which make use of the method according to the invention and the device according to the invention although using fundamentally different embodiments.

In each case, the recognition of the graphical features and the recognition of the structural features are independent from the contents and/or the function of the control elements 7. Accordingly, in particular no assessment of so called tags of the control elements 7 is necessary. In this way it is possible, automatically, to perform an identification without knowledge of the function of the control elements 7.

1-15. (canceled)

16. A method for automatically identifying at least one control element in an application view of an application, wherein
a) multiple recognition patterns for structural and graphical features of the at least one control element are pre-stored in an object template,
b) a recognition means generates structural and graphical data from the application view and examines the data according to the recognition patterns,
c) in dependence on the examination a measure for the recognition certainty of the recognition patterns is determined,
d) in dependence on the obtained recognition certainty the status of the at least one control element is determined as “identified” or “not identified”,
wherein at least one graphical recognition method for generating graphical data from the application view in combination with at least one structural recognition method for generating structural data from the application view is used, and
wherein the at least one structural recognition method communicates with the application and the at least one graphical recognition method works with a screenshot of an application view.

17. The method according to claim 16, wherein a recognition method generates, from the application view, at least one method object in dependence on the at least one recognition pattern as at least partial representation of a control element.

18. The method according to claim 17, wherein at least one candidate for a control element is generated from at least one method object, and wherein the best candidate is chosen according to the measure for the recognition certainty.

19. The method according to claim 16, wherein the at least one recognition method comprises information about the application and/or the application view, in particular about the structure of the application and/or application view.

20. The method according to claim 19, wherein the at least one recognition method comprises the Windows API, the MSAA, an HTML structure, an XML structure, a native Excel model, a native Word model, a SAPGUI Script and/or Java.

21. The method according to claim 20, wherein at least two recognition methods and/or recognition patterns are combined with each other.

22. The method according to claim 16, wherein the at least one method object comprises information about a type, a position, an ID, a font type, a color value, a dimension, a reference image and/or a rectangle.

23. The method according to claim 16, wherein a graphical object, in particular a rectangle, is identified as method object according to selected color points of the boundary by means of a recognition pattern.

24. The method according to claim 16, wherein the examination of the data from the application view for their structural and/or graphical characteristics takes place independent from the contents and/or the function of the at least one control element.

25. The method according to claim 16, wherein the examination of the data from the application view takes place in dependence of a presumed position of the at least one control element.

26. The method according to claim 16, wherein the recognition patterns are combined in at least one object template, and wherein the at least one object template describes a class of control elements.

27. The method according to claim 16, wherein graphical recognition methods using different graphical primitives are used in combination for generating graphical data from the application view.

28. A device for automatically identifying at least one control element, comprising:
at least one pre-stored object template with multiple recognition patterns for structural and/or graphical features of the at least one control element, and
a recognition means for generating structural and graphical data of the application view and examining the data according to the recognition patterns,
wherein in dependence on the examination a measure for the recognition certainty of the recognition patterns is determinable and in dependence on the obtained recognition certainty at least one control element is identifiable,
wherein at least one graphical recognition method for generating graphical data from the application view in combination with at least one structural recognition method for generating structural data from the application view is used, and wherein the at least one structural recognition method communicates with the application and the at least one graphical recognition method works with a screenshot of an application view.
